(19) United States
(12) Patent Application Publication
(10) Pub. No.: US 2025/0125846 A1
(43) Pub. Date: Apr. 17, 2025

(54) BEAMFORMING FOR SATELLITE NETWORKING SYSTEMS

(71) Applicant: Hughes Network Systems, LLC, Germantown, MD (US)

(72) Inventor: Victor Liau, Gaithersburg, MD (US)

(21) Appl. No.: 18/913,248

(22) Filed: Oct. 11, 2024

Related U.S. Application Data
(60) Provisional application No. 63/544,088, filed on Oct. 13, 2023.
(60) Provisional application No. 63/614,901, filed on Dec. 26, 2023.

(51) Int. Cl. H04B 7/06

(52) U.S. Cl. CPC H04B 7/0617

(57) ABSTRACT

Methods, systems, and apparatus, including computer programs encoded on computer-storage media, for beamforming for satellite networking systems. In some implementations, a beamforming system includes multiple processors. Each of the processors has a data link to communicate with a modem, and each of the processors has a data link to communicate with each of the other processors. Each of the processors is configured to communicate with a different subset of antenna elements of an antenna array. The beamforming system is configured to perform beamforming processing for each of multiple beams for each sampling period in a sequence of sampling periods. The processing can include distributing communication between the beamforming system and the antenna array among the multiple processors for each of the sampling periods. The processing can include varying which of the processors performs beamforming processing for the different sampling periods according to a predetermined pattern.

### CROSS-REFERENCE TO RELATED APPLICATIONS

This application claims the benefit of priority to U.S. Provisional Patent Application No. 63/544,088, filed on Oct. 13, 2023, and to U.S. Provisional Patent Application No. 63/614,901, filed on Dec. 26, 2023, the entire contents of which are incorporated herein by reference.

### BACKGROUND

The present specification relates to beamforming in wireless communication systems, including beamforming using spatial and temporal partitioning.

Beamforming is a technique that can be used by antenna arrays to perform directional signal transmission or signal reception. When transmitting, beamforming can be performed by controlling the phase and relative amplitude of the various signals output by antenna elements, to create patterns of constructive and destructive interference to direct a beam. For reception, the beamformer can apply different weightings to the signals received by different antenna elements to create directional sensitivity patterns. Beamforming can be computationally intensive, especially when multiple beams are used concurrently.

### SUMMARY

In some implementations, a system performs beamforming using multiple processors, which can increase performance in several ways. The system can partition the beamforming processing spatially and/or temporally. For example, the system can use spatial partitioning by distributing beamforming processing among multiple processors. The system can also use temporal processing to divide the processing for different sample times or time steps among different processors. For example, one processor can perform processing for samples with a first time index, another processor can perform processing for samples with a second time index, and so on. In this manner, processing for each successive time step can switch or alternate among a group of processors, allowing each processor a period with a duration of multiple sample periods to complete processing of a set of samples. This allows the processors to operate at lower speeds or lower throughput, which can increase reliability, reduce power consumption, reduce radiation-induced errors, and provide many other benefits.

Beamforming can be a very effective communication technique at many different locations in a network. For example, in a satellite communication network, a beamformer can be used in the payload of a satellite to communicate with multiple terrestrial gateways and/or multiple satellite terminals (e.g., very small aperture terminals (VSATs)). Similarly, a terrestrial gateway may use a beamformer to communicate with multiple satellites. Beamforming can be effective for many other devices, including aircraft, unmanned aerial vehicles (UAVs), and others.

In many applications, there are constraints on the beamformer hardware. For example, in a satellite payload, there is limited space, limited power available, and limited waste heat removal. In addition, satellites are often exposed to high levels of radiation, which can induce errors in digital equipment. Achieving reliability in a high-radiation environment may require derating of component capabilities, such as operating processors and other digital devices at lower clock speeds, lower throughput, or with other limitations compared to the rated capability on the ground. Even for applications other than in satellites, many systems have power constraints and size or volume constraints for communication hardware.

It is often desirable to increase the communication capacity of communication system, and for beamformers, this often involves the ability to concurrently operate using multiple beams. For example, a satellite or other system using a beamformer may need to receive or transmit with a dozen beams, several dozen beams, or a hundred or more beams concurrently. In addition, this may involve using antenna arrays that include dozens, hundreds, or thousands of antenna elements. Operating a beamformer at a large scales creates significant challenges. For example, the computational complexity of beamforming processing increases as the number of concurrent beams increases and as the number of antenna elements increases. As another example, the higher the number of beams and antenna elements, the more inputs and outputs are needed, which can quickly exceed the number of input and output pins on a processor.

In addition, it is often desirable to maximize communication throughput by using a high frequency, which also increases computational demands of beamforming. For example, the higher the frequency, e.g., the higher the symbol rate or sample rate, the higher the rate of computation (e.g., matrix operations, such as multiply and add) that needs to be performed. As a result, in many cases a single beamforming processor may not be able to consistently perform the amount of calculations required. For example, the desired number of beams, desired number of antenna elements, and desired sampling frequency in many situations may exceed the rate of computations that a processor can perform in the limited duration of one sample period. If the processor cannot complete processing for a set of samples before the next set of samples arrives, the processor would not be able to sustain communication in that configuration. Moreover, in a satellite, aircraft, or other constrained environment, using much larger or higher-frequency processor may be too large, too power hungry, or too expensive to use.

The present techniques enable efficient beamforming with increased scaling in the number of concurrent beams and the number of antenna elements that can be used, as well as increase the overall throughput of the beamformer (e.g., symbol rate or sample rate). The techniques can provide these improvements in capacity and performance while meeting the requirements of operation in satellite payloads and other constrained environments, where constraints such as limited power, limited size, and robustness to radiation are required. For a given level of processor capability, these techniques can enable a beamformer system to provide performance several times that of an individual processor, with increased capacity to support more concurrent beams, more antenna elements, higher throughput (e.g., higher symbol rate or sample rate), and so on. As discussed below, the techniques allow a beamformer system to achieve high performance using multiple processors with relatively low capacity or relatively slow operating frequencies.

The techniques discussed herein enable a beamformer to operate efficiently using multiple processors to spread computational load among multiple processors and reduce the maximum processing capability of each individual processor. Using multiple processors also increases the number of input and output pins, often far beyond what even a very large and expensive processor can provide, which gives higher capacity for a large number of concurrent beams and antenna arrays with large numbers of elements.

By partitioning the processing in time among the different processors, the system can operate at high sample rates, often much higher than any of the individual processors could support. For example, the system can partition the processing of data for different time steps or sampling periods among multiple processors, so that different processors perform the beamforming calculations for different sampling periods. The system can cycle through the processors to achieve a higher throughput than any of the processors could otherwise support.

For example, given a particular configuration of a system (e.g., a given number of concurrent beams, number of antenna elements, and frequency of sampling), the amount of computation required may be high enough that a processor may need a nearly four sampling periods to complete the beamforming processing needed for the data from just one sampling period (e.g., one set of samples). The system can use four processors, cycling through them in a sequence, to achieve the desired throughput of the beamforming system. The system can assign a first processor to perform the calculations for the first sampling period (e.g., processing the first set of samples). While the first processor is still performing the calculations for the first set of samples, a second set of samples arrives for a second sampling period. The system assigns a second processor to perform the calculations for the second set of samples, and the second processor begins the calculations for the second sampling period in parallel with the first processor continuing the calculations for the first sampling period. The system assigns a third processor to perform the calculations for the third sampling period, and a fourth processor to perform calculations for the fourth sampling period. At the fifth sampling period, the first processor has completed calculating the results for the first sampling period and sends those results, and so the first processor is available to begin processing samples for the fifth sampling period. Similarly, at the sixth sampling period, the second processor has completed calculating the results for the second sampling period and sends those results, and so the second processor is available to begin processing samples for the sixth sampling period. The system can continue cycling through the processors in this manner. In other words, each processor handles the beamforming processing for every fourth sampling period, with an offset between them (e.g., the first processor performs calculations for sampling periods with index values 4n, the second processor calculates for sampling periods with index values 4n+1, the third processor performs calculations for sampling periods with index values 4n+2, and the fourth processor performs calculations for sampling periods with index values 4n+3).

Cycling through the processors allow each processor to spread processing of a set of samples over the duration of multiple sampling periods, while still enabling the beamforming system to provide an output at the sampling rate. Each processor handles the full set of beamforming calculations for a sampling period (e.g., for all beams or for all antenna elements), but does so for only a fraction of the sampling periods or time steps. There is a latency or delay between input of samples and the corresponding output due to the processing time (e.g., a delay of four sampling periods in the example above), but this latency can be accounted for in the communication system and the system provides high throughput by sustaining consistent beamforming output at the sampling rate.

In addition, the ability to cycle through multiple processors and adjust the duration of processing time available for each beamforming calculation increases the versatility and scalability of the system. The system is able to effectively use smaller or less-capable processors that operate at low power, by cycling through a sufficient number of the processors so that the processing for one sampling period can be done in the duration of the cycle as a whole. As another example, if a system needs higher performance (e.g., higher sampling rates or symbol rates, more concurrent beams, more antenna elements), this would increase the processing complexity or processing requirements for each sampling period and so processing may take longer. Nevertheless, the increased complexity or processing time can be accounted for by adding additional processors to the cycle, thus affording more time before each processor needs to complete processing for one sampling period and begin processing for another sampling period.

Partitioning the beamforming processing in time (e.g., for different time indices or sampling periods) also allows for additional improvements in the data transfer characteristics and routing of data. In many cases, it is advantageous to utilize the combined input and output capabilities of the multiple processors used. One way is to distribute communication between the beamforming system and the modem among the multiple processors for each of the sampling periods. For example, when the modem has data for transmission across the multiple beams, the modem can send the data for different subsets of the beams to different processors. This allows the data to be spread over the data links to different processors, with concurrent transmission across multiple data links. This allows transmission in parallel using lower speed connections that have better power efficiency and better reliability (e.g., robustness to radiation) than a single high-speed link to a single processor. The system can also use the latency in the processing to spread data transfers among the processors over time. For example, when a processor receives input for a sampling period for which it is not assigned to perform the beamforming calculations, the processor can send the data to the processor that is assigned to perform the calculation. The data transfer does not need to be performed immediately, however, because the assigned processor already received a portion of the input and so can begin its calculations for terms relating to those inputs. This provides the versatility for processors to use lower-speed and lower-power signaling for data transfers between the processors, which improves efficiency and reliability.

In one general aspect, a communication system includes: a beamforming system including multiple processors, wherein each of the processors has a data link to communicate with a modem, wherein each of the processors has a data link to communicate with each of the other processors, and wherein each of the processors is configured to communicate with a different subset of antenna elements of an antenna array; wherein the beamforming system is configured to perform beamforming processing for each of multiple beams for each sampling period in a sequence of sampling periods, including by: distributing communication between the beamforming system and the antenna array among the multiple processors for each of the sampling periods; and varying which of the processors performs beamforming processing for the different sampling periods according to a predetermined pattern.

In some implementations, performing beamforming processing includes, for each of one or more of the sampling periods, at least one of: calculating, based on input data for the respective beams, a set of excitation signals for the sampling period, wherein the set of excitation signals is configured to excite the antenna elements so that the input data for the respective beams is concurrently transmitted on the multiple beams; or calculating, based on input signals indicative of wireless signals received from the antenna elements, a set of inputs received for the sampling period, wherein the set of inputs includes an input for each of the multiple beams during the sampling period.

In some implementations, for each of the sampling periods, (i) only one of the processors is used to perform the beamforming processing for data corresponding to the sampling period, and (ii) the processor used to perform beamforming processing for the sampling period is determined according to the predetermined pattern.

In some implementations, varying which of the processors performs beamforming processing for the different sampling periods according to the predetermined pattern includes: cycling through the processors in a predetermined sequence.

In some implementations, varying which of the processors performs beamforming processing for the different sampling periods according to the predetermined pattern includes: assigning the processors to successively perform beamforming processing for different sampling periods or groups of sampling periods in a repeating pattern over the sequence of sampling periods.

In some implementations, varying which of the processors performs beamforming processing for the different sampling periods according to the predetermined pattern includes: operating the multiple processors so that different processors of the multiple processors concurrently process data for different sampling periods, wherein each processor performs beamforming processing for a sampling period over a span of multiple sampling periods.

In some implementations, each of the sampling periods has a same duration; the beamforming system is configured to provide an output at a rate corresponding to the duration of the sampling periods; and the beamforming system provides output for each sampling period at an offset from the sampling period, such that output for a sampling period occurs at a predetermined number of multiple sampling periods after the beamforming system receives input corresponding to the sampling period.

In some implementations, the sequence of sampling periods includes multiple transmission sampling periods corresponding to data to be transmitted using the antenna array; the processors are configured to provide output signals indicating excitation of different subsets of the antenna elements; and, for each of the transmission sampling periods, one or more of the processors designated to perform beamforming processing for the transmission sampling period according to the predetermined pattern distributes beamforming output for the transmission sampling period to the other processors using the data links among the processors, such that each of the other processors receives the beamforming outputs that specify excitation for its corresponding subset of the antenna elements.

In some implementations, the processors are assigned to provide output signals for distinct subsets of the antenna elements, and the assignments of processors to the antenna elements are maintained consistent over the sequence of sampling periods; and each of the processors receives, from the other processors, the calculated beamforming outputs for its assigned subset of the multiple beams for each of the transmission sampling periods in which the processor is not designated to calculate the beamforming outputs according to the predetermined pattern.

In some implementations, each processor provides output signals for its assigned subset of the antenna elements for each transmission sampling period, including when one of the other processors performed the calculation of beamforming outputs for the subset of antenna elements.

In some implementations, each of the processors is configured to store beamforming outputs for its assigned subset of the antenna elements until a time for output corresponding to the transmission sampling period; and the beamforming system synchronizes the output of the output signals from the processors to provide, for each transmission sampling period, the output signals for all of the antenna elements at an output time corresponding to the transmission sampling period.

In some implementations, the beamforming system is configured to provide beams for communication by a satellite to satellite terminals.

In some implementations, the multiple beams comprise spot beams of a satellite, each of the spot beams corresponding to a different coverage area.

In some implementations, each of the processors includes a field-programmable gate array (FPGA).

In some implementations, each of the processors includes multiple beamforming engines or processing blocks, and wherein the predetermined pattern includes cycling through the different beamforming engines or processing blocks of the multiple processors.

In another general aspect, a computer-implemented method includes: receiving input data for transmission with an antenna array that includes multiple antenna elements, wherein the input data includes input data for each of multiple beams; based on the input data, determining a set of samples for each sampling period in a sequence of multiple sampling periods, wherein each set of samples includes a sample for each of the multiple beams; and using multiple processors to perform beamforming processing for each of the sampling periods in the sequence of sampling periods, including varying which of the multiple processors are used to perform the beamforming processing for different sampling periods according to a predetermined pattern.

In some implementations, varying which of the multiple processors are used to perform the beamforming processing for different sampling periods according to the predetermined pattern includes cycling through the processors in a predetermined sequence.

In some implementations, varying which of the multiple processors are used to perform the beamforming processing for different sampling periods according to the predetermined pattern includes: operating the multiple processors so that different processors of the multiple processors concurrently process data for different sampling periods, wherein each processor performs the beamforming processing for a sampling period over a span of multiple sampling periods.

In some implementations, the sequence of sampling periods includes multiple transmission sampling periods corresponding to data to be transmitted using the antenna array; the processors are configured to provide output signals indicating excitation of different subsets of the antenna elements; and, for each of the transmission sampling periods, one or more of the processors designated to perform beamforming processing for the transmission sampling period according to the predetermined pattern distributes beamforming output for the transmission sampling period to the other processors using data links among the processors, such that each of the other processors receives the beamforming outputs that specify excitation for its corresponding subset of the antenna elements.

In another general aspect, a computer-implemented method includes: receiving input signals from antenna elements of an antenna array for each sampling period in a sequence of multiple sampling periods; providing different subsets of the input signals or samples of the input signals to different processors in a set of multiple processors; and for each of the sampling periods in the sequence of multiple sampling periods: transferring, among the multiple processors, samples of the input signals such that a particular subset of the processors obtains the samples for each of the antenna elements of the antenna array; and using the particular subset of the processors to perform beamforming processing to determine a received input for each of multiple beams; where the subset of the multiple processors are used to perform the beamforming processing for different sampling periods is varied according to a predetermined pattern.

In some implementations, the subset comprises a single processor, such that the beamforming calculations for each sampling period is performed by only one processor.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for performing beamforming in a satellite communication network.

FIG. 2 is a block diagram showing an example of a beamforming system using multiple processors.

FIG. 3 is a diagram that illustrates an example of beamforming processing.

FIG. 4 is another diagram that illustrates an example of beamforming processing.

Like reference numbers and designations in the various drawings indicate like elements.

### DETAILED DESCRIPTION

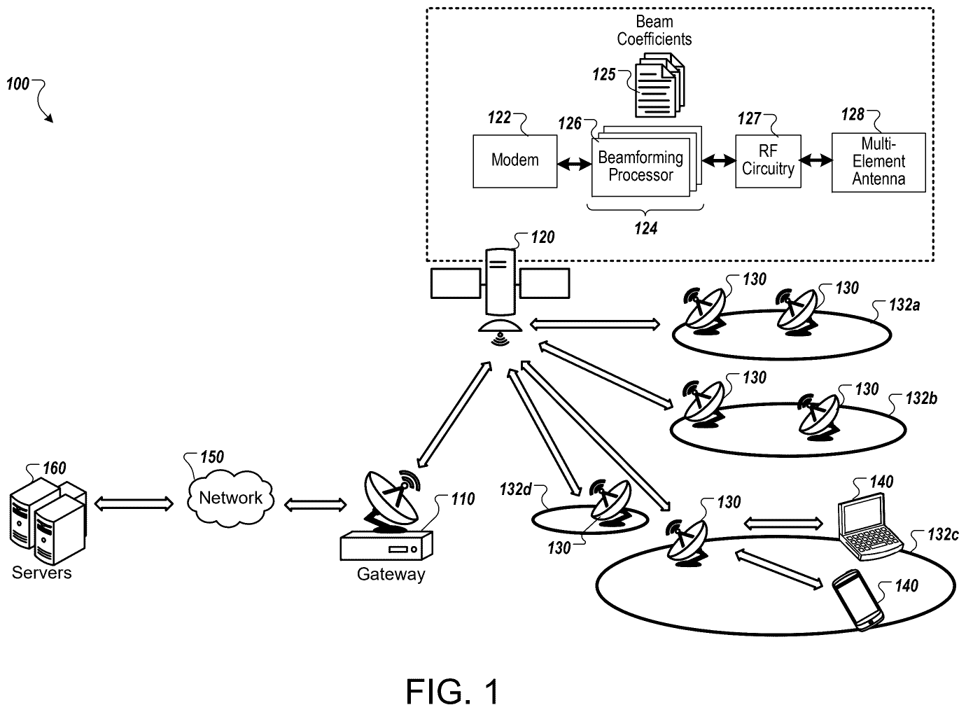

FIG. 1 is a diagram showing an example of a system 100 for performing beamforming in a satellite communication network. The system 100 includes a satellite gateway 110, a satellite 120, and various satellite terminals 130. The gateway 120 and the satellite 120 provide a radio access network so that the terminals 130 can each provide network connectivity to client devices 140, such as desktop computers, laptop computers, cellular phones, wearable devices, and so on. The gateway 120 provides communication with one or more other networks 150, which can include public and/or private networks and wireless and/or wired networks, and which can include the Internet. Due to the satellite network, client devices 140 have the network connectivity to can communicate with servers 160, other client devices 140, or other devices.

The satellite terminals 130 are distributed across different coverage areas 132a-132d. Each coverage area 132a-132a is served by a different beam, e.g., spot beam, from the satellite 120. The satellite 120 is configured to provide coverage concurrently for each of the coverage areas 132a-132d using the various beams. For example, for each sampling period for forward channel communication (e.g., transmission to terminals 130), the satellite 120 can use its antenna provide an output that simultaneously transmits data for each of the multiple beams. Similarly, for each sampling period for return channel communication (e.g., transmission from terminals 130 to the satellite 120) the satellite can use the antenna to simultaneously receive transmitted data for each of the multiple beams.

The satellite 120 includes a variety of components that operate together to send and receive data. These include a modem 122, a beamforming system 124 that includes multiple beamforming processors 126, radiofrequency circuitry 127, and an antenna 128 with multiple antenna elements (e.g., an antenna array with multiple dipole elements). The modem 122 performs modulation of data streams for transmission on the forward channel, and performs demodulation of received signals from the return channel. The beamforming system 124 performs beamforming processing for forward channel communication, such as receiving modulated data for multiple beams and generating antenna activation signals that will produce the beams carrying the symbols of the modulated data. The beamforming system 124 also performs beamforming processing for return channel communication, such as receiving samples of detected signals from the antenna 128 and determining the detected symbols for each of the beams. The radiofrequency circuitry 127 includes elements such as filters, power amplifiers, and other circuitry to condition and distribute signals between the beamforming system 124 and the antenna 128. The processors 126 of the beamforming system 124 can be field-programmable gate arrays (FPGAs), application-specific integrated circuits (ASICs), central processing units (CPUs), digital signal processors (DSPs), or other types of processors.

In further detail, the beamforming system 124 receives the modulated data streams to be transmitted on the forward channel for each of the beams and performs beamforming processing so that the data for the various beams is transmitted in the appropriate spatial directions. This involves performing calculations of the amplitude and phase of each of the antenna elements for each sampling period. In other words, the beamforming system 124 takes into account the contribution of each beam on the activation of the antenna elements, and calculates activation signals that will together create the multiple concurrent beams each transmitting the appropriate. To perform this, the beamforming system 124 can use multiple processors that each have access to matrices of beam coefficients 125. The multiple processors can perform matrix operations, e.g., multiplication and addition, using the beam coefficients 125 to determine an amplitude and phase for each antenna element of the antenna 128 for each sampling period used for transmission.

The beamforming system 124 also performs beamforming processing for receiving data on the return channel. For example, the beamforming system receives sampled input from each of the antenna elements, for each of various sampling periods used for reception. For each reception sampling period, the beamforming system 124 calculates a received input for each of the different beams, and provides the received inputs to the modem 122 for demodulation. In this process, the beamforming system 120 again uses the matrices of beamforming coefficients 125 to calculate, from the samples from the antenna elements, an input for each of the beams.

The beamforming system 124 includes multiple processors 126 that perform beamforming processing, and the beamforming system 124 distributes various functions among the multiple processors 126. For example, the beamforming system 124 partitions the beamforming processing in time, with different processors 126 being assigned to process samples for different sampling periods. The beamforming system 124 can use different subsets of the processors to perform processing for different sampling periods. For example, the beamforming system 124 can vary which of the processors performs beamforming processing for the different sampling periods according to a predetermined pattern. One way that this can be done is to cycle through the processors in a predetermined order, and then repeat the cycle.

For example, the beamforming system 124 can use five processors 125, P1 to P5, to process sets of samples S1, S2, S3, etc. for each of multiple sampling periods in a sequence, e.g., t1, t2, t3, etc. The beamforming system can cycle through the processors for each sampling period, so the processing for each sampling period is done by a single processor 125, but the system switches or alternates among the processors 125 for different sampling periods. As a result, the load is distributed among the processors 125 so each processor only needs to process a fraction of the total sets of samples. The processing is pipelined or sequenced, so that there is a delay between the reception of a set of samples and the calculation of the output. For example, if it takes a processor five sampling periods to complete the beamforming calculations for a set of samples, there will be a latency of five sampling periods between input and output. However, by cycling among five processors, output can be provided consistently at the sample rate.

The table below illustrates an example in which the beamforming system 124 changes the processor 125 used for each sampling period. Each time index represents a sampling period, and a new set of samples to be processed is determined for each sampling period. In this example, processor P1 performs processing for sampling periods with a time index value of 5n (e.g., 0, 5, 10, 15, etc.), processor P2 performs processing for sampling periods with a time index of 5n+1 (e.g., 1, 6, 11, 16, etc.), processor P3 performs processing for sampling periods with a time index of 5n+2 (e.g., 2, 7, 12, 17, etc.), and so on.

| Time Index | Processing events |
|---|---|
| 0 | |
| 1 | Processor P1 begins beamforming |
| | calculations for |
| | samples from time t0 |
| 2 | Processor P2 begins beamforming |
| | calculations for |
| | samples from time t1 |
| 3 | Processor P3 begins beamforming |
| | calculations for |
| | samples from time t2 |
| 4 | Processor P4 begins beamforming |
| | calculations for |
| | samples from time t3 |
| 5 | Processor P5 begins beamforming |
| | calculations for |
| | samples from time t4 |
| 6 | Processor P1 completes beamforming |
| | calculations for samples for |
| | time to and sends results; |
| | Processor P1 begins beamforming |
| | calculations for |
| | samples from time t5 |
| 7 | Processor P2 completes beamforming |
| | calculations for samples for |
| | time t1 and sends results; |
| | Processor P2 begins beamforming |
| | calculations for |
| | samples from time t6 |
| 8 | Processor P3 completes beamforming |
| | calculations for samples for time |
| | t2 and sends results; |
| | Processor P3 begins beamforming |
| | calculations for |
| | samples from time t7 |
| 9 | Processor P4 completes beamforming |
| | calculations for samples for |
| | time t3 and sends results; |
| | Processor P4 begins beamforming |
| | calculations for |
| | samples from time t8 |
| 10 | Processor P5 completes beamforming |
| | calculations for samples for time |
| | t4 and sends results; |
| | Processor P5 begins beamforming |
| | calculations for |
| | samples from time t9 |
| 11 | Processor P1 completes beamforming |
| | calculations for samples for time |
| | t5 and sends results; |
| | Processor P1 begins beamforming |
| | calculations for |
| | samples from time t10 |

The beamforming system 124 can partition the processing in time in other ways. For example, the beamforming system 124 can assign each processor 125 to perform processing for samples for a group of sampling periods, rather than switching for every sampling period. For example, the beamforming system 124 can switch processors 125 every four sampling periods, so that the first processor performs processing for samples from sampling periods with time indices 20n to 20n+3 (e.g., time indices 0-3, 20-23, 40-43, etc.), the second processor performs processing for samples from sampling periods with time indices 20n+4 to 20n+7 (e.g., time indices 4-7, 24-27, 44-47, etc.), and so on. Assigning sets of samples for groups of consecutive sampling periods may be useful when each physical processor 125 has multiple engines (e.g., processing cores, execution units, logical processors) that can separately perform the processing for different sets of samples (e.g., using separate hardware resources of the processor).

The beamforming system 124 can take advantage of the features of multiple processors in multiple ways. As noted above, partitioning the calculation in time can allow each processor 125 a longer duration to complete the beamforming calculations for a sampling periods (e.g., by spacing the calculations out over multiple sampling periods), while still meeting high throughput requirements such as a set of beamforming outputs for each sampling period.

The beamforming system 124 can also partition portions of the process in space, by distributing the inputs and outputs across the multiple processors 125. For example, for a given sampling period, the inputs to or outputs from the modem 122 can be divided among the multiple processors 125. Each processor 125 can be assigned a different subset of the multiple beams that the satellite 120 supports. If there are 100 beams and 5 processors, the modem 122 can provide data for 20 beams to each of the 5 processors (e.g., data for beams 1-20 exchanged with processor P1, data for beams 21-40 exchanged with processor P2, and so on). Distributing the communication with the modem 122 and the processors 125 in this way, using multiple data links in parallel, enables data transfer between the modem 122 and the beamforming system 124 to be completed with lower speeds (e.g., lower data rates) and lower power data links than a single, higher-speed link. The processors 125 can coordinate to route their data among themselves, taking advantage of the latency introduced by cycling among the processors to again use lower speed data links that conserve power and have higher tolerance to radiation.

In a similar manner, the beamforming system 124 can distribute communication with the antenna elements of the antenna 128 across the multiple processors 125. Each processor 125 can be assigned to communicate with (e.g., provide signals to or receive signals from) a different subset of the antenna elements. For example, if there are 1000 antenna elements, the processors 125 can be configured to send signals to or receive signals from distinct subsets of 200 of the antenna elements. A first processor can be configured to communicate with antenna elements 1-200, a second processor can be configured to communicate with antenna elements 201-400, and so on. This allows input and output for a large number of antenna elements to be provided using processors that individually would not have the capability or throughput to communicate with so many antenna elements. The beamforming system 124 is also scalable, as the number of antenna elements that are supported, both in terms of input and output capability and computation capacity, can be increased by increasing the number of processors 125. The beamforming system 124 can also make use of processors that have moderate or relatively low capabilities (e.g., in terms of amount of inputs and outputs, data rate of inputs and outputs, processing speed, etc.). Compared to using large and fast processors, a combination of smaller processors can still achieve high throughput for a large number of antenna elements, while additionally allowing lower-speed, more robust data links and operating at lower power.

In the example of FIG. 1, the beamforming system 124 is shown as part of the payload of the satellite 120. Nevertheless, the beamforming system 124 or similar features can be used in many other applications, such as in the gateway 110 to enable communication with multiple satellites, aircraft, or other devices using multiple beams. Similarly, the beamforming system 124 can be used in aircraft, ground-based vehicles, unmanned or autonomous vehicles, terminals, and other devices.

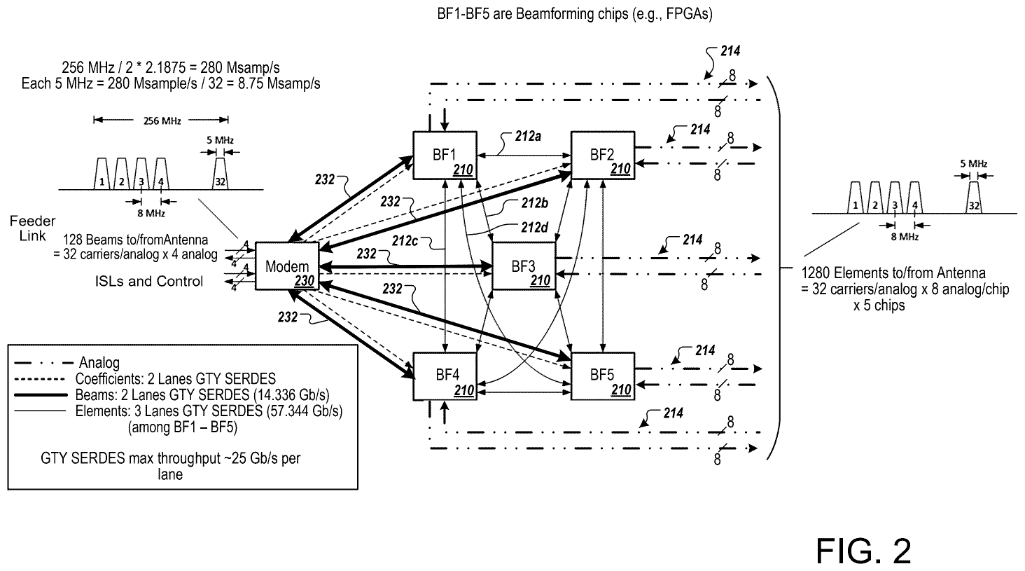

FIG. 2 is a block diagram showing an example of a beamforming system 200 using multiple processors 210. The beamforming system 200 is an example of a beamforming system 124 that can be used in the system 100 of FIG. 1. In the example, five processors 210 are used to performing the beamforming processing for 128 beams to or from an antenna that has 1280 antenna elements.

The beamforming system includes five beamforming processors 210, labelled BF1-BF5. In the example, each of the processors 210 is an FPGA. Each processor 210 (e.g., each FPGA chip) is configured with four beamforming engines that can each separately work on beamforming calculations for the samples of a different sampling period. Other arrangements may use more or fewer beamforming engines per processor chip.

In general, the beamforming system 200 can use multiple instances of beamforming engines (e.g., multiple processors 210 that each include one or more beamforming engines) that can each separately calculate the full matrix multiplication needed for the processing for all beams, to give results for all antenna elements for some finite amount of sample time. For example, for a given transmission sampling period, data for all j beams is provided to a single beamforming engine to create all i antenna element outputs. The beamforming system 200 uses a sufficient number of instances (e.g., beamforming engines) so that each beamforming engine can process the batch of samples for a sampling period during the duration of a cycle, in which the other beamforming engines are concurrently processing their batches of samples. The data transfer or distribution of input samples to (e.g., for reception) and output samples from (e.g., for transmission) the beamforming engines can be sent spread over time, reducing the maximum throughput required of the processing chip input and output (I/O), e.g., the serializer and deserializer (SERDES) blocks. The same SERDES used to send local inputs (e.g., antenna element samples) can be used to send processed outputs to other processors 210. Local outputs arrive from other chips using the same SERDES to receive inputs from other chips.

In some implementations, the calculation of all beam inputs (e.g., received data for all 128 beams) for a sampling period is co-located at a single processor 210 or beamforming engine. The calculation of all antenna element outputs (e.g., outputs for activating all 1280 antenna element) can also be co-located at a single processor 210 or beamforming engine. This provides various advantages, such as being easier to test and debug, allows simpler synchronization and sample alignment among the processors 210, and, if necessary, allows simpler application of global manipulation of inputs and outputs such as automatic gain control across all antenna elements. In addition, this feature makes the system more easily scalable to increase the number of beams or number of antenna elements by adding more processors 210, since the routing of data is relatively straightforward and there dependencies in the calculations are avoided (e.g., processors 210 do not need to exchange partial results or partial sums in the beamforming calculations).

Beamforming processing generally include applying beamforming coefficients to samples, e.g., in the forward channel, applying to samples of signals for transmission, and in the return channel, applying to coefficients to samples of signals detected by the antenna elements. One example can include 128 beams (j=128) using 1280 antenna elements (i=1280) with beamforming coefficients c_{i,j} and with beam j samples bⱼ[n] and element i samples eᵢ[n]. For the forward channel, the calculation of element outputs can be represented as eᵢ[n]=Σₖ₌₀^{N-1}c_{l,k}bₖ[n] for i=0 . . . 1279 and N=128. For the return channel, the calculation of received beam samples can be represented as bⱼ[n]=Σₖ₌₀^{N-1}c_{k,j}eₖ[n] for j=0 . . . 127 and N=1280.

The processors 210 are connected with digital communication links so each of the processors 210 has a dedicated data link to each of the other processors 210. For example, the processors 210 can be connected in a fully-connected mesh network. As an example, the processor BF1 has data links 212a-212d, where data link 212aprovides a connection to processor BF2, where data link 212b provides a connection to processor BF3, where data link 212c provides a connection to processor BF4, and where data link 212d provides a connection to processor BF5. Each of the other processors 210 similarly has four data links, each dedicated for communication to the other processors 210.

The processors 210 each have analog interfaces 214 to communicate with antenna elements of an antenna array. The processors 210 can each include or be associated with analog-to-digital converters (ADCs) and digital-to-analog converters (DACs) to support the analog interfaces. In the example, the beamforming system 200 is configured to communicate with an antenna array that has 1280 antenna elements. Each processor 210 has input/output capability for 8 concurrent analog inputs and/or 8 concurrent analog outputs. In some implementations, the processors 210 use a first set of analog ports and transmission lines for output to the antenna elements (e.g., through radiofrequency circuitry), and a second set of analog ports and transmission lines for input from the antenna elements (e.g., through radiofrequency circuitry). In other implementations, the ports and/or transmission lines are shared for input and output, and the signals are simply routed or processed differently depending on whether the beamforming system is currently being used for transmission or reception.

The processors 210 use frequency division multiplexing to send analog signals on multiple carriers for each analog output, and to receive analog signals on multiple carriers for each analog input. For example, each processor 210 has 8 analog outputs, and 32 signals are frequency-division multiplexed onto each output line. This results in transmission on 32 carriers at a time on each analog output line. As an example, 5 MHz can be designated for each carrier, and the central frequencies for each carrier can be 8 MHz apart. For a single processor 210, 32 carriers for each of 8 analog output lines results in 256 concurrent analog outputs. Collectively, for the five processors 210 taken together, there are 1280 concurrent outputs (e.g., 32 carriers per analog output×8 analog outputs per processor×5 processors=1280 outputs). The same frequency-division multiplexing is used for the analog inputs to the processors, resulting in 1280 analog inputs, with 256 of the inputs being provided to each processor 210.

The analog interfaces of the processors 210 are used to communicate with the antenna elements, such as to send signals for driving the antenna elements during transmission and to receive signals detected by the antenna elements during reception. The example of FIG. 2 involves an antenna with 1280 antenna elements (e.g., dipole elements). The beamforming system is configured so that each processor 210 communicates with a different subset of the antenna elements. For example, processor BF1 sends signals to and receives signals from antenna elements 1-256, processor BF2 sends signals to and receives signals from antenna elements 257-512, processor BF3 sends signals to and receives signals from antenna elements 513-768, processor BF4 sends signals to and receives signals from antenna elements 769-1024, and processor BF5 sends signals to and receives signals from antenna elements 1025-1280. This means that each processor 210 communicates with its corresponding set of antenna elements for each sampling period, e.g., to receive signals detected by the antenna elements if the sampling period is used for reception or to send signals to excite the antenna elements if the sampling period is used for transmission. The assignment of the processors 210 to the respective sets of antenna elements can be maintained or held consistent across many throughout a series of sampling periods, including different periods of transmission and reception. In some implementations, the connections between the processors 210 and their respective antenna elements are fixed and unchanging.

As discussed below, this arrangement means that for each transmission sampling period, each of the processors 210 is used to send signals to its corresponding subset of antenna elements. This occurs even though a subset of the processors 210 or even a single processor 210 performs the calculation of the output for the sampling period (e.g., including calculating outputs for all of the antenna elements and taking into account the data to transmit on all the beams). When the subset of processors 210 or the single processor 210 has made the calculations for a sampling period, the data is distributed among the processors 210 so that they can synchronously provide all the outputs and the entire set of antenna elements can be driven at the same time.

For example, the processor BF1 can be assigned to perform the beamforming processing for a set of samples for a particular time index t1. The set of samples includes a value for each of the 128 beams, representing the data or symbols to be transmitted for each of the 128 beams. The processor BF1 can perform the beamforming processing by calculating an output (e.g., a complex number indicating amplitude and phase) for each of the 1280 antenna elements, such that the antenna output will simultaneously create beams with the spatial orientations for the various destinations or coverage areas and also transmit in each beam the corresponding data for the beam. Once the processor BF1 completes the calculations for the samples corresponding to time index t1 (which typically occurs several sampling periods or time indices after time index t1), the processor BF1 is ready to transmit the analog outputs for its subset of the antenna elements (e.g., antenna elements 1-256). The processor BF1 does not immediately transmit the outputs, however, and first distributes the calculated outputs for the samples corresponding to time index t1 to the other processors 210, e.g., using the data links 212a-212d to send the outputs for antenna elements 257-512 to processor BF2, sending outputs for antenna elements 513-768 to processor BF3, sending outputs for antenna elements 769-1024 to processor BF4, and sending outputs for antenna elements 1025-1280 to processor BF5. The processors coordinate the data transfer and synchronize their outputs to the antenna elements. As a result, all of the processors 210, e.g., BF1 to BF5, all provide analog signals together for their respective subsets of antenna elements, where the signals are based on the outputs that processor BF1 calculated for the samples corresponding to time index t1.

Similar features can be used for reception also. For example, when signals are received by the antenna, each processor 210 receives the signals for the antenna elements in its corresponding subset of antenna elements (e.g., 1-256 for processor BF1, 257-512 for processor BF2, and so on). The processors 210 transfer digital samples for their subset of antenna elements to the processor 210 that is assigned to perform the beamforming processing for that sampling period. For example, if processor BF2 is assigned to process the samples for a particular sampling period, then processors BF1, BF3, BF4, and BF5 each transfer digital samples corresponding to their respective subsets of the antenna elements to processor BF2 over their digital data links with processor BF2. As a result, processor BF2 receives all of the samples of received antenna signals (e.g., samples for all 1280 antenna elements) that are needed to perform beamforming processing for that particular sampling period, including to determine received data or received symbol for each of the 128 beams. The pattern of switching or rotating among the processors 210 can be predetermined, so that each processor 210 can (i) easily and accurately determine which processor 210 needs the samples to perform the beamforming processing for the corresponding sampling period and (ii) route the samples to the appropriate processor 210.

The consistency of assignments between the processors 210 and antenna elements improves reliability, ease of testing, and overall robustness by simplifying the routing of data among the processors 210. Each of the processors 210 can store data indicating that, or the processors can be configured so that, for example, data for antenna elements 1-256 is always is sent to (or is received by) the processor BF1, data for antenna elements 257-512 is always sent to (or is received by) the processor BF2, and so on. The beamforming system 200 can take advantage of the combined bandwidth of the analog interfaces of all of the processors 210 each sampling period, even as each processor 210 only performs beamforming calculations for a subset of the sampling periods.

To conserve power and increase reliability, including in the presence of radiation, it is advantageous to avoid very bursty transmission patterns. Spreading communication among the processors 210 out over the cycle of through the processors 210 (e.g., over multiple sampling periods) can achieve a lower, more consistent average data rate. This is beneficial during transmission and reception. In transmission, the distribution of calculated beamforming outputs from one processor 210 to all of the processors 210 can be spread over time. Similarly, for reception, the collection of detected antenna element signal samples from the various processors 210 to a single processor can be spread over time. In general, the arrangement of using multiple processors in a cycle increase the amount of time available for both beamforming calculations and data transfer, and this decreases the importance of quickly gathering all samples to the particular processor 210 designated to perform calculations for that sampling period. For example, if the processor BF3 is designated perform beamforming processing for reception corresponding to a particular sampling period, the processor BF3 will initially receive signals for, and generate the samples for, its corresponding set of antenna elements (e.g., antenna elements 513-768) before receiving the samples for other antenna elements corresponding to the other processors 210. As a result, the processor BF3 can begin calculating portions (e.g., terms) of the outputs involving the samples for its assigned antenna elements, even before receiving the samples for other antenna elements from other processors 210. In addition, the extended period for calculation allows the other processors BF1, BF2, BF4, and BF5 to send their samples with a relatively low data rate that spaces the transmission over one or more subsequent sampling periods. For example, if each cycle includes 20 sampling periods (e.g., cycling through four beamforming engines each of five different processors 210), then processors 210 can take advantage of low-power, high-reliability signaling, even with low data rates, to transmit their samples over 1, 2, 3, or more sampling periods within the overall cycle duration.

The beamforming system 200 can enable communication of a modem 230 with each of the multiple processors 210. The modem 230 is configured to send and receive data for each of the 128 beams. For example, the modem 230 can send and receive data on a wireless feeder link from a terrestrial gateway, where the feeder link provides data for four analog input lines to the modem 230, with each analog input line carrying data on 32 carriers (e.g., 4 analog input lines×32 carriers per analog input line=128 inputs). Each of the four inputs to the modem can have a bandwidth of about 256 MHZ, using 32 channels of 5 MHz each, with adjacent carriers spaced apart by 8 MHZ.

Each of the processors 210 has a separate data link 232 to communicate with the modem 230. When transmitting data, there will be a sample (e.g., a value) representing data to be transmitted for each beam for each transmission sampling period. Using 128 beams, this results in 128 values for each transmission sampling period. There is typically sufficient throughput on each data link 232 for the modem 230 to provide the samples for all beams directly to the processor 210 designated to perform beamforming processing for that sampling period. In other words, if processor BF1 is designated to perform beamforming processing for a particular sampling period according to the predetermined pattern of cycling through the processors 210, then the set of samples for all beams for that sampling period can be provided from the modem 230 directly to the processor BF1. When the pattern of cycling through the processors indicates that the processor BF2 is performing processing for a sampling period, the set of samples for the beams can be sent to processor BF2, and so on.

Cycling through the processors 210 changes which processor 210 performs the calculations for different sampling periods in a series of sampling periods. As a result, the modem 230 may need to track and determine which processor 210 to send each set of samples to. Alternatively, the modem 230 may send full sets of samples for all beams to all processors 210 for each transmission sampling period, or the beamforming system 200 may include an additional routing element to pass the set of samples for each transmission sampling period to the correct processor 210. To avoid these complexities in routing, the system can use other techniques. For example, the modem 230 may consistently send the set of samples for each transmission sampling period to a single processor 210, so the same processor 210 receives the full set of samples for transmission for each transmission sampling period. This processor 210 can then send the set of samples to each of the other processors 210, as needed to fulfill the predetermined pattern of cycling.

As another example, the processors 210 can each be assigned a different subset of the beams, so that each processor 210 consistently receives data for the same subset of beams from the modem 230 for each transmission sampling period. With 128 beams and five processors 210, three of the processors 210 can exchange data with the modem 230 for 26 beams each and two of the processors 210 can exchange data with the modem 230 for 25 beams each. For example, the processor BF1 is assigned beams 1-26, processor BF2 is assigned beams 27-52, the processor BF3 is assigned beams 53-78, processor BF4 is assigned beams 79-103, and the processor BF5 is assigned beams 104-128.

For transmission, the modem 230 provides a set of samples for each sampling period, where the set of samples includes a sample for each of the 128 beams. The samples for the beams are divided or distributed among the processors 210 using the predetermined assignments, so that each processor 210 consistently receives samples for the same subset of the beams. Distributing the transmission of samples this way reduces the data rate required for communication between the modem 230 and individual processors 210, since the communication can be spread over five data links 232 rather than a single data link. The processors 210 then provide the samples for their subset of beams to the processor 210 assigned to perform the beamforming processing for the particular sampling period or time index. As a result, even though each processor 210 receives samples for its corresponding subset of beams for each transmission sampling period, all the samples for the transmission sampling period (e.g., samples for all of the beams) will be gathered at the processor 210 that will be performing the beamforming processing for this sampling period.

As discussed above, the beamforming system 210 uses a predetermined pattern of switching or cycling among the processors 210. Often, the predetermined pattern is known in advance by each of the processors 210 and is used consistently. In some implementations, the pattern can be adjusted, reset, or specified by one of the processors 210 or another processor to synchronize and coordinate the processing of the processors 210.

For example, for a particular transmission sampling period, the predetermined pattern may designate the processor BF3 to perform the beamforming processing for the current sampling period. Each of the processors BF1-BF5 determines that the processor BF3 is the processor to perform the beamforming processing for this sampling period. As a result, processors BF1, BF2, BF4, and BF5 each send their received samples for this sampling period, representing data for transmission for their subsets of the beams, to the processor BF3. The processor BF3 can then perform beamforming processing for this sampling period over several subsequent sampling periods, before completing the calculations and distributing the calculated results (e.g., outputs specifying amplitude and phase for each of the antenna elements) back among the other processors BF1, BF2, BF4, and BF5 for output to the antenna elements.

For transmitting received data, the throughput of each data link 232 to the modem 232 is generally sufficient to enable a single processor 210 to send an entire set of received data (e.g., return channel data for a sampling period for each of the 128 beams). As a result, when the predetermined pattern for cycling among the processors 210 indicates that the processor BF1 calculates the received data for a particular sampling period, then the processor BF1 will send the received data to the modem 230 over its data link 232. Similarly, if the predetermined pattern designates one of the other processors BF2-BF5 to perform the return channel processing for a sampling period, that processor can send the received data to the modem 230 over its data link 232.

In the example of FIG. 2, the beamforming calculations, whether for transmission or reception, are localized to a single processor. For example, a set of samples for transmission are processed by one processor 210, where that calculation can be spread out over time through the cycle, and then the calculation results are distributed among the processors 210 for output to the antenna elements. Similarly, for reception, each of the processors 210 generates samples representing antenna inputs for its corresponding subset of the antenna elements, and then the samples for all antenna elements are collected at a single processor 210 that performs the beamforming processing for reception (e.g., determining a sample or value for each beam from the antenna element samples and each different beam's beamforming coefficients) for that sampling period, where the processing is spread over the duration of the cycle. Localizing the processing to a single processor for each sampling period can greatly simply routing and data transfer in the system, as well as make testing and debugging easier.

The beamforming calculations for each sampling period may be assigned to and performed by a subset of the processors 210, and the subset of processors 210 used may vary in a cycle over the course of a sequence of sampling periods. In some implementations, the subset of processors 210 used to process data for a sampling period may be more than one. For example, it may be advantageous in some cases to use two processors 210 for each sampling period, to reduce the overall cycle duration, to allow larger scale, or adjust other characteristics of the system.

When transmitting data, the throughput required for data transfer among the processors 210, e.g., for sending calculation results for the elements, is reduced by the spreading the data transmission over at least some of the total processing time of a cycle. In the case of five processors 210 each with 4 beamforming engines, not only can the processing time be spread out, but the transmission time can also be spread out. In other words, the processor 210 calculating results does not need to wait until all antenna element output values are calculated to begin distributing results to the other processors 210. Even early in the cycle duration, the processor 210 can begin distributing antenna element calculations to the other processors 210 as soon as those calculations are completed. The processors can various identifiers or arrangements to specify and track, for each transmitted output value, which sampling period and antenna element the value corresponds to. In some cases, the cycle duration may be increased beyond the number of sampling periods needed strictly for computing the result, to allow additional transmission time (e.g., if 18 sampling periods are needed to complete calculations, the cycle may be extended to 25 or 30 sampling periods to further spread out transmission time). This may incur additional time offset between the receipt of the data from the modem for transmission to the output of analog signals for the antenna, but in many cases the increased reliability and power savings can justify a very small increase in latency.

Similarly, when receiving data, the throughput required for receiving input data for antenna elements can be reduced by spreading the data transmission over multiple sampling periods in the cycle. For example, whichever processor 210 is assigned in the cycle for a particular reception sampling period can begin performing at least partial calculations using the samples for its corresponding subset of the antenna elements, even before the input samples for other antenna elements are received from the other processors 210. Once the final set of input samples is received, the partial calculation results can be completed and the received values for each beam can be determined. In other words, a processor 210 can begin reception processing before and during the transmission of input samples from other processors 210 which allows efficient use of processing resources while allowing the transmission of input samples among the processors 210 to be done at lower transfer rates.

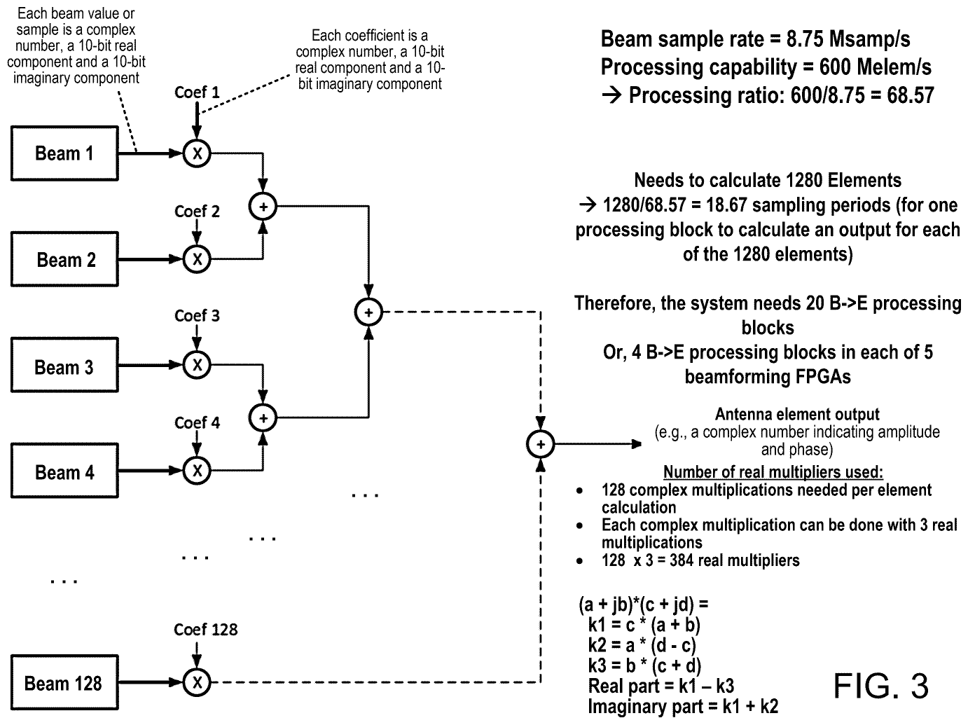

FIG. 3 is a diagram that illustrates an example of beamforming processing. The diagram shows an example of how processing can be performed for one antenna element, such as to generate a complex number that specifies the amplitude and phase to drive an antenna element during transmission. The example of processing shown would be performed for each of the antenna elements (such as each of the 1280 antenna elements discussed above for the example of FIG. 2) for each transmission sampling period. This involves using processing blocks that translate or convert from beam data (“B”) to antenna element (“E”) excitation outputs, or “α->E” as indicted in FIG. 3.

Generating the output for an antenna element for a particular sampling period involves combining the contributions of each of the beams for the antenna element activations. As shown in FIG. 3, the contribution of each beam is determined using a matrix of coefficients for each beam. When calculating the output for a particular element, there is a multiplication for each beam, and the results are summed to create the overall value for the antenna element. The multiplication operations shown, between data for a beam and a corresponding coefficient, are a complex multiplications. The complex multiplication can be performed using three real multiplications. For example, for a complex multiplication (a+jb)*(c+jd) where j is an imaginary unit, three real multiplications can be performed (e.g., k1=c*(a+b), k2=a*(d−c), and k3=b*(c+d)). Then the values of k1, k2, and k3 can be used to determine the real part and the imaginary part of the result (e.g., where the real part=k1-k3, and the imaginary part=k1+k2).

The number of processors 210 and beamforming engines per processor can be set to achieve desired timing characteristics given the capabilities of the processors 210 (e.g., processing clock speed, number of clock cycles for each multiplication and addition operation, etc.) and the communication throughput desired (e.g., the beam sample rate that supports the desired communication data rate). In the example of FIG. 3, a beam sample rate of 8.75 megasamples per second (“Msamp/s”) is chosen, and the processing capability is 600 million element calculations per second (“Melem/s”), resulting in a processing ratio of 68.57 (e.g., 68.57 element calculations for each sampling period). There are 1280 antenna elements, and so 1280 antenna element outputs need to be calculated for each sampling period. As a result, a processing block or engine would need 1280/68.57=18.67 sampling periods to calculate the output for one set of samples of data to be transmitted over the 128 beams (e.g., for one transmission sampling period).

As a result, given the processing capability of the processors and/or processing blocks or engines used, the system can use a cycle with a duration of 19 or more sampling periods to achieve the throughput needed. In this case, the system is configured to use a cycle with a duration of 20 sampling periods, and so to repeatedly cycle through 20 different processing blocks or beamforming engines in sequence. This creates a pipelining effect, where latency is added between receipt of the input samples and the output of the result (e.g., antenna element activation values), but the desired throughput and sample rate can be maintained. In this case, where the processors 210 are FPGAs, each processor 210 is programmed to have four processing blocks or beamforming engines, and the predetermined patterns includes cycling through the different beamforming engines. For example, engine 1 of processor BF1 processes samples for time index 1, engine 2 of processor BF1 processes samples for time index 2, engine 3 of processor BF1 processes samples for time index 3, engine 4 of processor BF1 processes samples for time index 4, engine 1 of processor BF2 processes samples for time index 5, engine 2 of processor BF2 processes samples for time index 6, engine 3 of processor BF2 processes samples for time index 7, engine 4 of processor BF2 processes samples for time index 8, and so on.

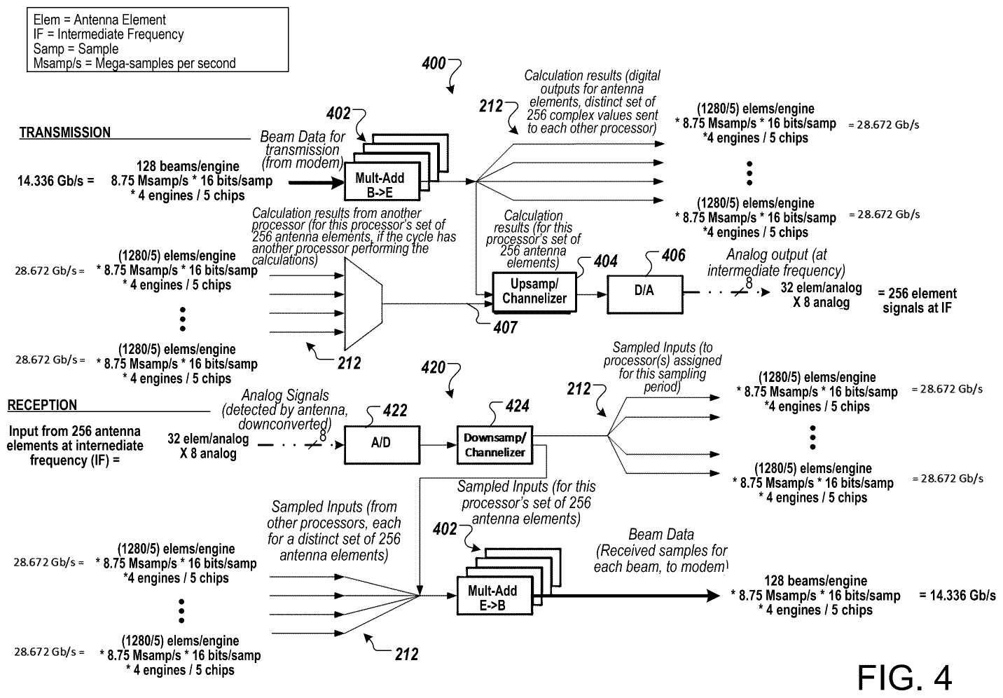

FIG. 4 is another diagram that illustrates an example of beamforming processing. The example shows data flow for a single processor 210 (e.g., a single integrated circuit, FPGA, etc.), as the processor 210 would be used in transmission or reception. The same techniques would be used for each of the multiple processors 210, e.g., such as with five instances cooperating as shown in FIG. 2.

A first example 400 shows processing performed for beamforming used for transmission, e.g., forward channel communication from a satellite to a terminal. As discussed above, the system can vary which processor 210 is used to perform beamforming calculations for different sampling periods, for example, by cycling through the processors and/or through multiple beamforming engines of the processors. In the illustrated example, each processor 210 has four beamforming engines 402, which have separate hardware resources in the processor 210 so each beamforming engine 402 can operate separately to concurrently process different sets of samples.

When the processor 210 for which processing is represented in FIG. 4 is designated to perform beamforming calculations for a particular sampling period, the processor receives beam data for transmission, received from the modem 230. This beam data can include a set of samples, including a sample for each of the 128 beams of the system. The data is routed to the appropriate beamforming engine 402 of the processor 210, according to current position in the predetermined pattern or cycle. The beamforming engine 402 performs the multiplication and addition operations of FIG. 3 to calculate an output specifying excitation characteristics (e.g., amplitude and phase) for each of the 1280 antenna elements of the antenna. This processing is spread over multiple sampling periods.

Once the beamforming engine 402 has completed the beamforming calculations, the processor 210 distributes the calculated outputs for the antenna elements to the other processors 210 over data links 212 with the other processors. For example, each of the five processors 210 is coupled to provide output for one fifth of the antenna elements, e.g., each processor 210 provides output signals for a distinct set of 256 of the 1280 antenna elements. The processor 210 uses the calculated outputs for its own assigned subset of antenna elements. This includes providing those 256 outputs to an upsampler and channelizer 404, which provides output to a DAC 406, which provides output on 8 analog output lines. Each analog output line includes analog signals for 32 different antenna elements, and these signals are frequency multiplexed to include 32 carriers. This results in a total of 256 analog outputs over the 8 analog output lines. These can be, for example, analog outputs at an intermediate frequency, for upconversion or mixing by radiofrequency circuitry to drive the antenna elements. For example, the outputs will then be processed further by radiofrequency circuitry to, for example, demultiplex, mix, filter, upconvert, amplify, or otherwise condition the signals and route them to drive the corresponding antenna elements. The other processors 210 each generate analog outputs to be used to drive their corresponding subsets of the antenna elements also. The system synchronizes the output among the processors 210 so that the antenna elements are all driving by the outputs for the same sampling period.

For transmission sampling periods in which a processor 210 is not designated to perform the beamforming coefficients, one or more of the beamforming engines 402 will typically be busy processing sets of samples for other sampling periods assigned to them in the predetermined pattern. Nevertheless, as other processors 210 complete their calculations, they will distribute their calculation results to each other processor 210 for the subset of antenna outputs to which it is assigned. This is shown as a second input 407 to the upsampler an channelizer 404, where the beamforming calculation results (e.g., digital output of the complex values) for the 256 antenna elements assigned to the current processor 210 are received from whichever of the other processors 210 performed the calculations for that sampling period. Each processor 210 will transmit analog output for its corresponding subset of antenna elements for each transmission sampling period, whether the processor 210 was assigned to calculate the output for that sampling period or the processor 210 received the calculation result from another processor 210. In the example of FIG. 4, the data links 212 are illustrated a second time as carrying input for the upsampler and channelizer 404, to show that these data links are used to receive calculation results for subset of antenna elements assigned to the processor represented in FIG. 4 when the calculation is done by other processors 210.

For example, when using a cycle with a duration of 20 sampling periods, each processor 210 has four beamforming engines 402 that can each separately perform the processing to calculate antenna element signals from beam data (e.g., samples or values of data to be transmitted), which is indicated as beam-to-element or “B->E” processing. Each processor 210 calculates the beamforming results for one fifth of the sampling periods, or four out of the 20 sampling periods in each cycle. Nevertheless, the processors 210 all provide output to their corresponding subsets of antenna elements for every sampling period. For each sampling period, the processor 210 performing the calculations for that sampling period will distribute the calculation results to the other processors 210. Each processor 210 will output signals based on either received calculation results (e.g., if a different processor was assigned to perform calculations for that sampling period) or its own calculation results (e.g., for sampling periods that the processor was assigned to perform the calculations).

A second example 420 shows data flow for reception. For each sampling period used for reception (e.g., reception sampling period), the processor 210 receives analog signals for each of the antenna elements in the subset of antenna elements that are assigned to that processor 210. In this example, this includes a total of 256 antenna element inputs, provided on 8 analog input lines, with each input line carrying 32 frequency-multiplexed signals (e.g., signals on 32 different carriers). These analog signals can be inputs at an intermediate frequency, e.g., after each having been downconverted by radiofrequency circuitry. The processor 210 uses an ADC 422 to convert the input to digital form, and then uses a downsampler and channelizer 424 to create input samples for each of the 256 antenna elements. If the predetermined pattern or cycle does not designate the processor 210 to perform beamforming calculations for the current reception sampling period, the processor 210 sends its samples to whichever of the other processors 210 is designated to perform the calculations (e.g., over the appropriate data link 212 with that other processor 212).

If the predetermined pattern or cycle does designate the processor 210 to perform beamforming calculations for the current reception sampling period, then the processor 210 begins the processing to generate beam data from the sampled antenna element signals, using whichever of the beamforming engines 402 is appropriate given the predetermined pattern. The beamforming engine 402 uses the antenna signal samples to calculate beam data, e.g., a reception output for each of the 128 beams. The processor 210 receives antenna signal samples for the reception sampling period from the other processors over the data links 212 with those other processors 210. Each processor 210 provides the antenna signal samples for its corresponding subset of the antenna elements. However, the samples do not arrive immediately. The processors 210 can spread out their data transfers over time on the data links 212, so that a lower data rate permits lower power consumption and higher reliability. Once the beamforming engine 402 completes the beamforming processing for the reception sampling period (which may be multiple sampling periods after the sampling period in which the analog antenna signals were received), the processor 210 containing that beamforming engine 402 sends the received beam data (e.g., a received digital sample or value for each beam) to the modem 230.

In some implementations, a beamforming system can use spatial partitioning that does not locate processing for a each sampling period at a single processor 210. These techniques can be implemented using the same data links and connections shown for the beamforming system 200 of FIG. 2. Nevertheless, they represent different levels of requirements for processing speed and data transfer speed. For example, the alternative techniques may reduce latency, but may increase power consumption or require faster data transfer speeds, or increase the overall amount of data that needs to be transferred for each sampling period. The beamforming system 200 may be configured to switch between different beamforming arrangements as different modes, where each mode partitions the beamforming calculation differently to achieve different performance characteristics. This may be done by running software or firmware that allow a mode to be selected and applied, by downloading different programming code to the FPGAs, or through other techniques.

For the forward direction, one alternative way to partition the calculation is to use multiple processors 210 to calculate a subset number of the outputs for antenna elements using all of the beams. In this case, the modem 230 would provide the samples for transmission to each of the processors 210 concurrently, and each processor 210 would calculate output for each sampling period, but only for its specific subset of antenna elements. As another alternative technique, multiple processors 210 can be used to calculate output for a subset of the number of the antenna elements, using information for only a subset of the beams at first and then later adding the partial sums with other processors to produce the complete antenna element values. This version would involve each processor receiving samples for transmission for only a portion of the beams. The processors 210 would then exchange partial calculations (e.g., multiplication results, partial sums of multiplication results, etc.) and then sharing the partial calculation results, where each processor 210 would then use its own calculated data and received calculated data to produce the final set of antenna element outputs for the processor's own set of antenna elements.

For the return direction, one alternative way to partition the calculation is to use multiple processors 210 to calculate received samples for only a subset of the beams, but using received samples for all of the antenna elements. Each processor 210 would receive signals for and generate samples for its own corresponding set of antenna elements for each sampling period. The processors 210 would exchange their input samples so that, for each sampling period, each processor 210 obtains the full set of input samples (e.g., the input sample for each of the antenna elements). The processors 210 then operate in parallel to generate received beam data, but with each processor 210 only calculating the values for its own subset of beams (e.g., each processor 210 determining received samples for only 25 or 26 of the 128 total beams). As another alternative technique, multiple processors 210 can each be used to calculate received samples for a subset number of the beams, by not initially exchanging all of the input samples from the antenna elements but later exchanging multiplication results or partial sums. For example, each processor 210 can use coefficients from all the beams to generate multiplication results and partial sums for each of the beams but only for the 256 input samples from the antenna elements corresponding to that processor 210. The processors 210 all exchange their partial sums (e.g., for all beams, but each for their own set of antenna element inputs), and each processor completes the reception calculations for its assigned set of beams and provides the result to the modem 230.

In these alternative techniques for partitioning the processing, each processor 210 can still include multiple beamforming engines, and the system can switch or shift through these engines from one sampling period to the next. This can create an offset or cycle to mask the latency of processing delay and data transfer among the processors. In other words, instead of cycling through different processors 210, the system cycles through different beamforming engines or processing instances within each processor 210. For example, if the processing time and data transfer time requires 10 sampling periods, then each of the processors 210 can have 10 beamforming engines, and each processor 210 uses beamforming engine 1 for sampling period 1, beamforming engine 2 for sampling period 2, and so on, until the cycle repeats at sampling period 11 to use beamforming engine 1 again. Each processor 210 still receives inputs at each sampling period, and after the initial latency each processor 210 also provides outputs at each sampling period, with communication among the processors occurring as needed to support the calculation.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A communication system comprising:
a beamforming system comprising multiple processors, wherein each of the processors has a data link to communicate with a modem, wherein each of the processors has a data link to communicate with each of the other processors, and wherein each of the processors is configured to communicate with a different subset of antenna elements of an antenna array;
wherein the beamforming system is configured to perform beamforming processing for each of multiple beams for each sampling period in a sequence of sampling periods, including by:
distributing communication between the beamforming system and the antenna array among the multiple processors for each of the sampling periods; and
varying which of the processors performs beamforming processing for the different sampling periods according to a predetermined pattern.

2. The communication system of claim 1, wherein performing beamforming processing comprises, for each of one or more of the sampling periods, at least one of:
calculating, based on input data for the respective beams, a set of excitation signals for the sampling period, wherein the set of excitation signals is configured to excite the antenna elements so that the input data for the respective beams is concurrently transmitted on the multiple beams; or
calculating, based on input signals indicative of wireless signals received from the antenna elements, a set of inputs received for the sampling period, wherein the set of inputs comprises an input for each of the multiple beams during the sampling period.

3. The communication system of claim 1, wherein, for each of the sampling periods, (i) only one of the processors is used to perform the beamforming processing for data corresponding to the sampling period, and (ii) the processor used to perform beamforming processing for the sampling period is determined according to the predetermined pattern.

4. The communication system of claim 1, wherein varying which of the processors performs beamforming processing for the different sampling periods according to the predetermined pattern comprises:
cycling through the processors in a predetermined sequence.

5. The communication system of claim 1, wherein varying which of the processors performs beamforming processing for the different sampling periods according to the predetermined pattern comprises:
assigning the processors to successively perform beamforming processing for different sampling periods or groups of sampling periods in a repeating pattern over the sequence of sampling periods.

6. The communication system of claim 1, wherein varying which of the processors performs beamforming processing for the different sampling periods according to the predetermined pattern comprises:
operating the multiple processors so that different processors of the multiple processors concurrently process data for different sampling periods, wherein each processor performs beamforming processing for a sampling period over a span of multiple sampling periods.

7. The communication system of claim 1, wherein each of the sampling periods has a same duration;
wherein the beamforming system is configured to provide an output at a rate corresponding to the duration of the sampling periods; and
wherein the beamforming system provides output for each sampling period at an offset from the sampling period, such that output for a sampling period occurs at a predetermined number of multiple sampling periods after the beamforming system receives input corresponding to the sampling period.

8. The communication system of claim 1, wherein the sequence of sampling periods includes multiple transmission sampling periods corresponding to data to be transmitted using the antenna array;
wherein the processors are configured to provide output signals indicating excitation of different subsets of the antenna elements; and
wherein, for each of the transmission sampling periods, one or more of the processors designated to perform beamforming processing for the transmission sampling period according to the predetermined pattern distributes beamforming output for the transmission sampling period to the other processors using the data links among the processors, such that each of the other processors receives the beamforming outputs that specify excitation for its corresponding subset of the antenna elements.

9. The communication system of claim 8, wherein the processors are assigned to provide output signals for distinct subsets of the antenna elements, and the assignments of processors to the antenna elements are maintained consistent over the sequence of sampling periods; and
wherein each of the processors receives, from the other processors, the calculated beamforming outputs for its assigned subset of the multiple beams for each of the transmission sampling periods in which the processor is not designated to calculate the beamforming outputs according to the predetermined pattern.

10. The communication system of claim 8, wherein each processor provides output signals for its assigned subset of the antenna elements for each transmission sampling period, including when one of the other processors performed the calculation of beamforming outputs for the subset of antenna elements.

11. The communication system of claim 8, wherein each of the processors is configured to store beamforming outputs for its assigned subset of the antenna elements until a time for output corresponding to the transmission sampling period; and
wherein the beamforming system synchronizes the output of the output signals from the processors to provide, for each transmission sampling period, the output signals for all of the antenna elements at an output time corresponding to the transmission sampling period.

12. The communication system of claim 1, wherein the beamforming system is configured to provide beams for communication by a satellite to satellite terminals.

13. The communication system of claim 1, wherein the multiple beams comprise spot beams of a satellite, each of the spot beams corresponding to a different coverage area.

14. The communication system of claim 1, wherein each of the processors comprises a field-programmable gate array (FPGA).

15. The communication system of claim 1, wherein each of the processors comprises multiple beamforming engines or processing blocks, and wherein the predetermined pattern comprises cycling through the different beamforming engines or processing blocks of the multiple processors.

16. A computer-implemented method comprising:
receiving input data for transmission with an antenna array that comprises multiple antenna elements, wherein the input data includes input data for each of multiple beams;
based on the input data, determining a set of samples for each sampling period in a sequence of multiple sampling periods, wherein each set of samples includes a sample for each of the multiple beams; and
using multiple processors to perform beamforming processing for each of the sampling periods in the sequence of sampling periods, including varying which of the multiple processors are used to perform the beamforming processing for different sampling periods according to a predetermined pattern.

17. The computer-implemented method of claim 16, wherein varying which of the multiple processors are used to perform the beamforming processing for different sampling periods according to the predetermined pattern comprises cycling through the processors in a predetermined sequence.

18. The computer-implemented method of claim 16, wherein varying which of the multiple processors are used to perform the beamforming processing for different sampling periods according to the predetermined pattern comprises:
operating the multiple processors so that different processors of the multiple processors concurrently process data for different sampling periods, wherein each processor performs the beamforming processing for a sampling period over a span of multiple sampling periods.

19. The computer-implemented method of claim 16, wherein the sequence of sampling periods includes multiple transmission sampling periods corresponding to data to be transmitted using the antenna array;
wherein the processors are configured to provide output signals indicating excitation of different subsets of the antenna elements; and
wherein, for each of the transmission sampling periods, one or more of the processors designated to perform beamforming processing for the transmission sampling period according to the predetermined pattern distributes beamforming output for the transmission sampling period to the other processors using data links among the processors, such that each of the other processors receives the beamforming outputs that specify excitation for its corresponding subset of the antenna elements.

20. One or more non-transitory computer-readable media storing instructions that are operable, when executed by one or more computers, to cause the one or more computers to perform operations comprising:
receiving input data for transmission with an antenna array that comprises multiple antenna elements, wherein the input data includes input data for each of multiple beams;
based on the input data, determining a set of samples for each sampling period in a sequence of multiple sampling periods, wherein each set of samples includes a sample for each of the multiple beams; and
using multiple processors to perform beamforming processing for each of the sampling periods in the sequence of sampling periods, including varying which of the multiple processors are used to perform the beamforming processing for different sampling periods according to a predetermined pattern.
